(19) United States
(12) Patent Application Publication
(10) Pub. No.: US 2010/0084427 A1
(43) Pub. Date: Apr. 8, 2010

(54) Folding Tube

(76) Inventor: Gerald E. Kardach, South Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/562,012

(22) Filed: Sep. 17, 2009

Related U.S. Application Data
(60) Provisional application No. 61/195,063, filed on Oct. 3, 2008.

(51) Int. Cl. B65D 35/02; B23P 17/04

(52) U.S. Cl. 222/107; 493/269; 493/287

(57) ABSTRACT

The present invention is a dispensing tube made from a single machining process, which utilizes novel tooling to create interlocking components directly on the existing surface of a toothpaste tube. In other embodiments, various interlocking and clip-on components may be utilized to create a dispensing tube that more efficiently extracts a viscous substance as the tube empties.

### CROSS-REFERENCE TO RELATED APPLICATIONS

This application claims priority to U.S. Provisional Application No.

61/195,063 filed on Oct. 3, 2008.

### FIELD OF INVENTION

The present invention relates to dispensing tubes and more particularly to structural components for folding the tubes and squeezing out the material to be dispensed.

### BRIEF DESCRIPTION OF THE DRAWINGS

FIG. 1a illustrates atop perspective view of an exemplary embodiment of a dispensing tube having textured sections which are integrally manufactured with the dispensing tube.

FIG. 1b illustrates a top perspective view of an exemplary embodiment of dispensing tube having including textured sections and scoring to facilitate the interlocking of textured sections.

FIG. 1c illustrates a top perspective view of a dispensing tube having textured sections and scoring engaged in a folded position.

FIG. 2a illustrates a side perspective view of an exemplary embodiment of first interlocking surface and second interlocking surface in the open position.

FIG. 2a illustrates a side perspective view of an exemplary embodiment of first interlocking surface and second interlocking surface in the closed position.

### GLOSSARY

As used herein, the term “interlocking” or “textured” refers to components which fit together to ensure coordinated action. Interlocking components may be locking or unlocking.

As used herein, the term “engage” means to attract and hold fast or secure.

As used herein, the term “scored” refers to a notch, line, cut or mark which facilitates folding or bending.

As used herein, the term “clip-on” refers to a component with a self-attached clip that can be easily secured.

As used herein, the term “molding” or “extrusion” refers to process of shaping or forming a component during manufacturing. Molding or extrusion may include, but is not limited to, stamping, embossing or pressing.

As used herein, the term “integrally formed” refers to components manufactured during a single process, e.g., molding, or out of a single piece of material.

As used herein, the term “dispensing tube” refers to any plastic or metal tube used to dispense a viscous material (including but not limited to toothpaste, a cosmetic, toiletry item, craft and repair items, pharmacueticals and other materials). The dispensing tube which dispenses a substance through .an opening when pressure is applied to the tube.

### BACKGROUND

Dispensing tubes are popular and inexpensive forms of packaging for toothpaste, cosmetics, and other-substances. A problem known in the art is that the substance stored in the tube becomes increasingly difficult and time, consuming to extract as the tube is emptied. Many attempts have been made and are known in the prior art for designing a dispensing tube or components which facilitate the folding and squeezing of the dispensing tube to reduce the amount of pressure which much must be applied, the distance the viscous substance has to travel to be extracted, and the amount of waste of the viscous substance.

One example is disclosed in U.S. Pat. No. 6,332,560 (Rosenberg '560). Rosenberg '560 teaches a tooth paste tube having “engaging elements” that are identified in the specification as small hook-like structures. Rosenberg '560 requires considerable manual dexterity, to engage the tiny hooks and clamp-like structures. The apparatus taught in Rosenberg '560 actually increases the amount of effort required to extract the viscous substance. In addition, it is costly to manufacture.

Another example in the prior art of an attempt to design an efficient toothpaste tube is disclosed in U.S. Pat. No. 7,007,823 (Jackson '823). Jackson '823 teaches a dispensing system that features continuous strips of hook and loop material that run the length of a tube to hold the emptied portion of the tube in a coiled or folded position. Although Jackson '823 teaches a tube dispensing system having a pair of mating hook and loop fastening strips designed to more easily secure the expended portions of a tube in a compact position, the strips must be affixed to the dispensing tube after manufacturing. The strips are also made of a proprietary substance and the system is costly to manufacture because strips must be separately cut and adhered to a tube. It is not practical or cost-effective to manufacture this system, and the process for doing so cannot be easily automated.

A third example is disclosed in U.S. Pat. No. 5,167,349 (Rodder et al. '349). Rodder et al. '349 teaches a method and device for folding a tube. An adhesive strip with a removable liner is attached lengthwise to the tube. As the used portion of the tube grows, the liner is gradually removed from the adhesive strip by the user, allowing the used portion to be rolled or folded into a compact configuration. Although Rodder '349 teaches a method and apparatus for compacting the expended portion of a tube, this apparatus also requires separately manufactured components and is un-hygienic because hair, dust, lint and other bacterial substances are attracted to an adhesive surface. In addition, it requires that the adhesive be attached to the tube after manufacturing and requires the user to subsequently remove segments of liner-from the adhesive strip which limits the locations where the tube can be folded.

It is desirable to have an efficient dispensing tube from which viscous substances can be easily extracted as the tube empties.

It is further desirable to have a tube which can be economically mass produced and manufactured.

### SUMMARY OF THE INVENTION

The present invention is a dispensing tube made from a single machining process, which utilizes novel tooling to create interlocking components directly on the existing surface of a toothpaste tube. In other embodiments, various interlocking and clip-on components may be utilized to create a dispensing tube that more efficiently extracts a viscous substance as the tube empties.

### DETAILED DESCRIPTION OF INVENTION

For the purpose of promoting an understanding of the present invention, references are made in the text to exemplary embodiments of a dispensing tube with interlocking components, only some of which are described herein. It should be understood that no limitations on the scope of the invention are intended by describing these exemplary embodiments. One of ordinary skill in the art will readily appreciate that alternate but functionally equivalent shapes, materials and mechanisms may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. in addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

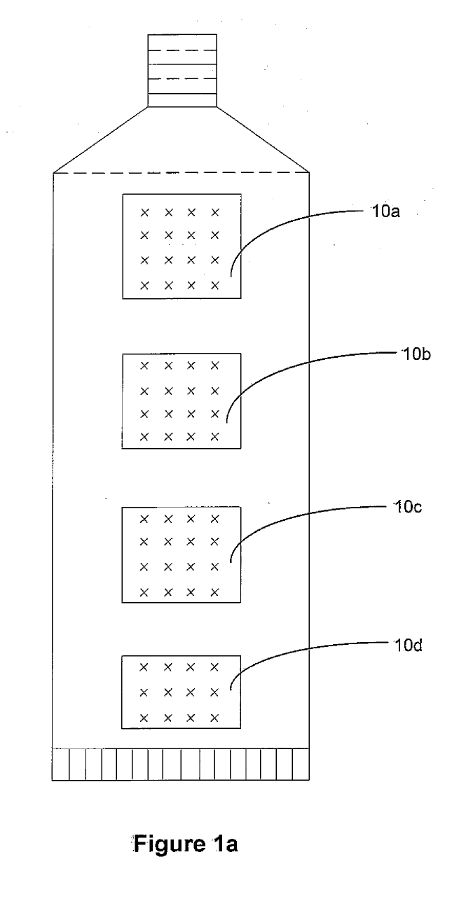

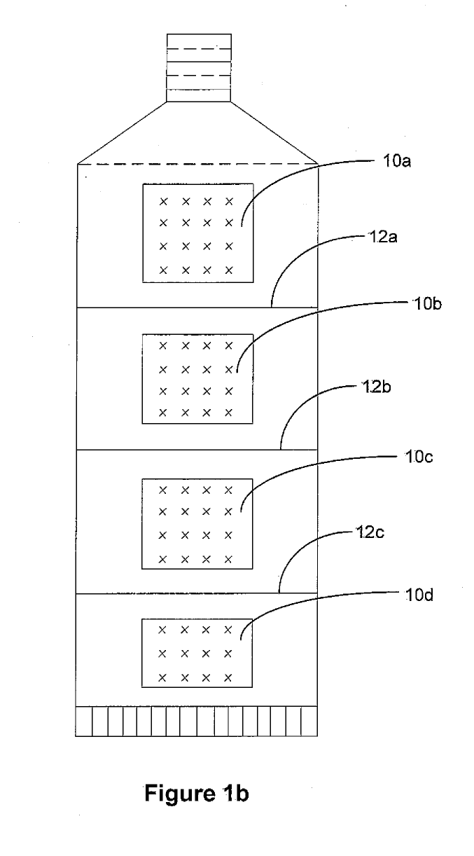

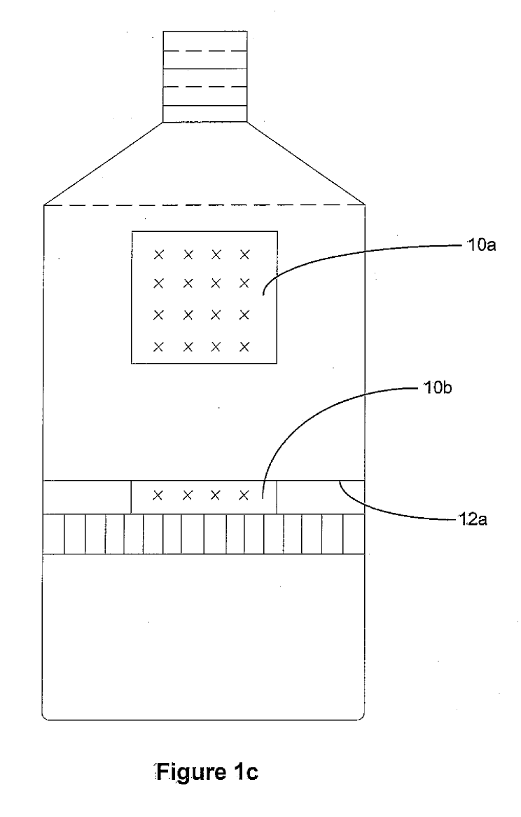

FIG. 1a illustrates a top perspective view of an exemplary embodiment of dispensing tube 100 having textured sections 10a, 10b, 10c and 10d which are integrally manufactured with the dispensing tube 100. In the embodiment shown, the textured sections are protrusions manufactured to engage each other. Dispensing tube 100 is manufactured by an extrusion process, molding, blow-molding, machining stamping or tooling. Textured sections 10a, 10b, 10c and 10d are then, created by a second rolling tool, stamping tool, imprinting device, molding surface or other method. In alternate embodiments, the textured sections of dispensing tube 100 may be created with a single mold, drum, rolling tool, die, stamp, extrusion, tool or other process known in the art.

FIG. 1b illustrates a top perspective view of an exemplary embodiment of dispensing tube 100; including textured sections 10a, 10b, 10c and 10d, and which is also scored at lines 12a, 12b and 12c to facilitate the interlocking of textured sections 10a, 10b, 10c and 10d. In the embodiment shown, the interlocking components are protrusions manufactured to engage each other.

FIG. 1c illustrates a top perspective view of dispensing tube 100 having textured section 10a, 10b, 10c and 10d and scoring 12a, 12b and 12c engaged in a folded position.

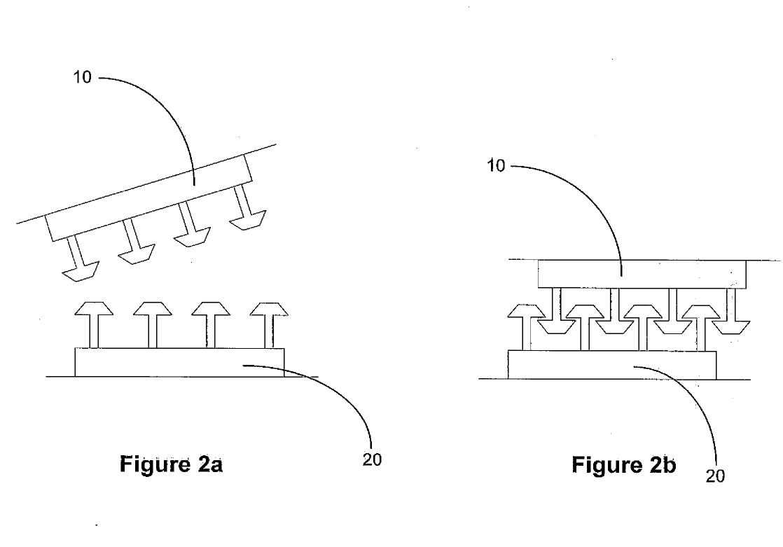

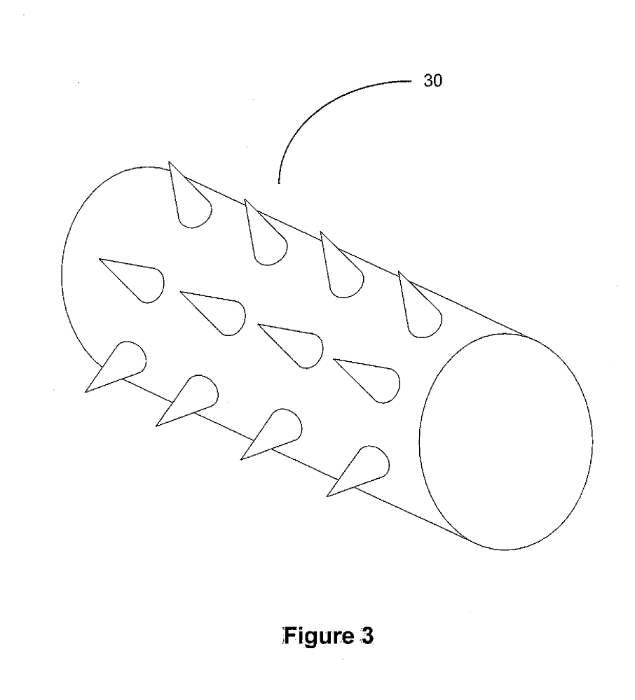

FIG. 2a illustrates a top perspective view of an exemplary embodiment of a first interlocking surface 10 and a second interlocking surface 20 in the open position. In alternate embodiments, interlocking components may be protrusions, hook-and-eye material (Velcro™), and may be of any length, dimensions, number and contour that allows two textured sections to engage.

FIG. 2b illustrates a top perspective view of an exemplary embodiment of a first interlocking surface 10 and a second interlocking surface 20 in the closed position.

FIG. 3 illustrates exemplary die and roller tool 30 used for creating textured sections on dispensing tube 100.

What is claimed is:

1. A dispensing tube comprised of:
a dispensing tube having a first surface;
and a second surface upon which a plurality of textured sections are integrally formed.

2. The apparatus of claim 1 wherein said textured sections are formed from a process consisting of cutting, stamping, imprinting, embossing, heat stamping, stamping, molding and tooling.

3. The apparatus of claim 1 wherein said textured sections include a plurality of protuberances which are fixedly attached to said second surface.

4. The apparatus of claim 1 wherein said textured sections are adapted to engage each other when said textured surfaces are placed in contact with each other.

5. The apparatus of claim 1 wherein said textured sections are removable.

6. The apparatus of claim 1 wherein said textured sections are removable and fixedly attached.

7. The apparatus of claim 1 wherein said textured sections are proportionately spaced at a distance of 0.2 inches to two inches apart.

8. The apparatus of claim 1 wherein said textured sections are disproportionately spaced at a distance of 0.2 inches to two inches apart.

9. The apparatus of claim 1 wherein said first surface is scored.

10. The apparatus of claim 1 wherein said second surface is scored.

11. The apparatus of claim 1 wherein said textured sections are clip-on components.

12. A method of making a dispensing tube comprised of:
molding a dispensing tube having a first surface and a second surface; and
embossing textured sections on said second surface.

13. The method of making a dispensing tube of claim 12 wherein said textured sections are formed from a process consisting of cutting, stamping, imprinting, embossing, heat stamping, stamping, molding and tooling.

14. The method of making a dispensing tube of claim 12 wherein said textured sections include a plurality of protuberances which are fixedly attached to said second surface.

15. The method of making a dispensing tube of claim 12 wherein said textured sections are adapted to engage each other when said textured surfaces are placed in contact with each other.

16. The method of making a dispensing tube of claim 12 wherein said textured sections are removable.

17. The method of making a dispensing tube of claim 12 wherein said textured sections are fixedly attached.

18. The method of making a dispensing tube of claim 12 which further includes the step of spacing said textured components at a distance of 0.2 inches to two inches apart so that they may be engaged when in contact.

19. The method of making a dispensing tube of claim 12 wherein said textured sections are disproportionately spaced at a distance of 0.2 inches to two inches apart.

20. The method of making a dispensing tube of claim 12 wherein said first surface is scored.

21. The method of making a dispensing tube of claim 12 which further includes the step of scoring said second surface.

22. The method of making a dispensing tube of claim 12 which further includes the step of attaching said textured sections utilizing clip-on components.
